(19) United States
(12) Patent Application Publication
(10) Pub. No.: US 2018/0313664 A1
(43) Pub. Date: Nov. 1, 2018

(54) STROKE DETECTOR

(71) Applicant: KYB Corporation, Tokyo (JP)

(72) Inventor: Tsukasa HEISHI, Kanagawa (JP)

(73) Assignee: KYB Corporation, Tokyo (JP)

(21) Appl. No.: 15/768,078

(22) PCT Filed: Dec. 16, 2016
(86) PCT No.: PCT/JP2016/087517

§ 371 Date: Apr. 13, 2018

(30) Foreign Application Priority Data
Dec. 24, 2015 (JP) 2015-252190

(51) Int. Cl. G01D 5/14; G01B 7/00

(52) U.S. Cl. CPC G01D 5/145; G01B 7/001

(57) ABSTRACT

Stroke detectors include magnetic detectors that output signals in accordance with magnetic fields that are changed by scales. The magnetic detectors include first hall elements that detect change in magnetic flux, first magnets that generate first magnetic field, and second magnets that generate the second magnetic field. The first magnets and the second magnets are arranged such that the first magnetic field and the second magnetic field are cancelled out in the first hall elements.

### TECHNICAL FIELD

The present invention relates to a stroke detector.

### BACKGROUND ART

Conventionally, stroke detectors are used for detecting the stroke of a linear motion part such as a cylinder. JP2004-286662A discloses a stroke detector in which a magnetic detection unit provided in a cylinder tube detects stroke of the cylinder by detecting scales provided on a surface of a piston rod. A magnetic detector of the stroke detector has a magnetic detection element that is arranged so as to oppose the scales and a magnet that is disposed on the other side of the magnetic detection element from the side opposing the scales.

### SUMMARY OF INVENTION

However, with the magnetic detection element described in JP2004-286662A, a maximum detection range is set in accordance with an intensity of a magnetic field generated by the magnet. As described above, because resolution is lowered if the detection range of the magnetic detection element is set to be large, when a changed amount of the stroke is small and a change in the magnetic field is small, it is difficult to detect a change in the magnetic field. As a result, there is a possibility that the detection precision of the stroke is deteriorated.

An object of the present invention is to improve a detection precision of a stroke of a linear motion part.

According to one aspect of the present invention, a stroke detector includes a scale provided on a surface of a second member provided so as to be capable of advancing/retracting with respect to a first member, the scale being provided along a advancing/retracting direction of the second member; and a magnetic detector provided on the first member so as to oppose the scale, the magnetic detector being configured to output a signal in accordance with magnetic field that is changed by the scale. The magnetic detector includes a first magnetic flux detection part configured to detect a change in magnetic flux in a direction perpendicular to the advancing/retracting direction of the second member, a first magnetic-field generating part configured to generate a first magnetic field, and a second magnetic-field generating part configured to generate a second magnetic field. The first magnetic-field generating part and the second magnetic-field generating part are arranged such that, in a state in which the magnetic detector is not opposing the scale, the first magnetic field and the second magnetic field are cancelled out in the first magnetic flux detection part.

### BRIEF DESCRIPTION OF DRAWINGS

FIG. 1 is a configuration diagram of a stroke detector according to a first embodiment of the present invention;

FIG. 2 is a sectional view along a II-II line in FIG. 1;

FIG. 3 is a sectional view along a line in FIG. 2;

FIG. 4A is a diagram for explaining a change in a magnetic field in the stroke detector according to the first embodiment of the present invention;

FIG. 4B is a diagram for explaining the change in the magnetic field in the stroke detector according to the first embodiment of the present invention;

FIG. 4C is a diagram for explaining the change in the magnetic field in the stroke detector according to the first embodiment of the present invention;

FIG. 4D is a diagram for explaining the change in the magnetic field in the stroke detector according to the first embodiment of the present invention;

FIG. 4E is a diagram for explaining the change in the magnetic field in the stroke detector according to the first embodiment of the present invention;

FIG. 5 is a graph showing an output from a magnetic detector of the stroke detector according to the first embodiment of the present invention;

FIG. 6 is an enlarged diagram of the magnetic detector of the stroke detector according to a first modification of the first embodiment of the present invention;

FIG. 7 is a sectional view along a VII-VII line in FIG. 6;

FIG. 8 is an enlarged diagram of the magnetic detector of the stroke detector according to a second modification of the first embodiment of the present invention;

FIG. 9 is a sectional view along a IX-IX line in FIG. 8;

FIG. 10 is a configuration diagram of the stroke detector according to a second embodiment of the present invention;

FIG. 11 is a sectional view along a XI-XI line in FIG. 10;

FIG. 12A is a diagram for explaining the change in the magnetic field in the stroke detector according to the second embodiment of the present invention;

FIG. 12B is a diagram for explaining the change in the magnetic field in the stroke detector according to the second embodiment of the present invention;

FIG. 12C is a diagram for explaining the change in the magnetic field in the stroke detector according to the second embodiment of the present invention;

FIG. 12D is a diagram for explaining the change in the magnetic field in the stroke detector according to the second embodiment of the present invention;

FIG. 12E is a diagram for explaining the change in the magnetic field in the stroke detector according to the second embodiment of the present invention; and

FIG. 13 is a graph showing an output from the magnetic detector of the stroke detector according to the second embodiment of the present invention.

### DESCRIPTION OF EMBODIMENTS

An embodiment of the present invention will be described below with reference to the drawings.

### First Embodiment

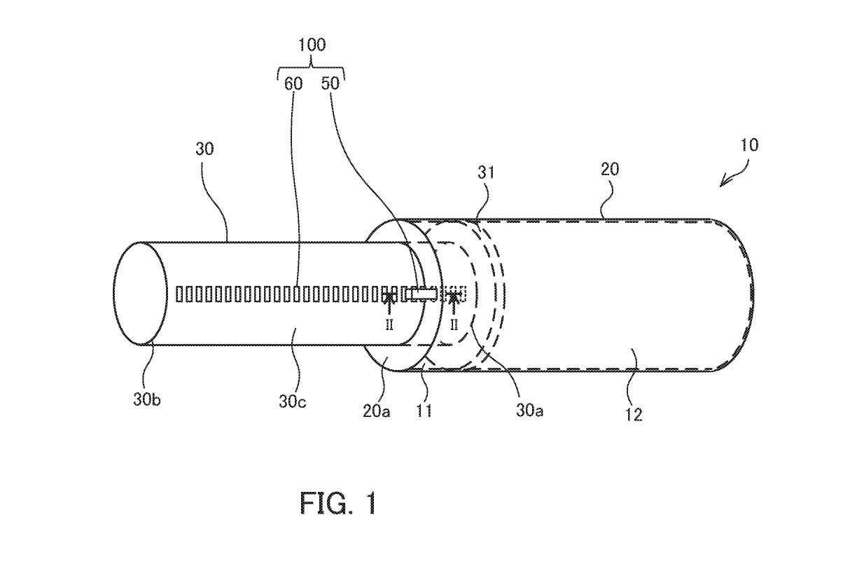

A stroke detector 100 according to a first embodiment of the present invention will be described with reference to FIGS. 1 to 3. A cylinder 10 shown in FIG. 1 is a hydraulic cylinder that is operated by working oil discharged from a hydraulic pump (not shown). The stroke detector 100 is provided in the cylinder 10.

The cylinder 10 includes a cylinder tube 20 serving as a first member that is a main body of the cylinder 10 and a piston rod 30 serving as a second member that is provided so as to be capable of advancing/retracting with respect to the cylinder tube 20. In other words, the cylinder 10 is a linear motion part in which the piston rod 30 moves in an advancing/retracting manner with respect to the cylinder tube 20.

The cylinder tube 20 has a cylindrical shape, and a piston 31 is provided in the cylinder tube 20 so as to be freely slidable in the axial direction. In addition, at an end portion of the cylinder tube 20, a cylinder head 20a through which the piston rod 30 is inserted in a freely slidable manner is provided. The interior of the cylinder tube 20 is divided into two oil chambers 11 and 12 by the piston 31.

The two oil chambers 11 and 12 are connected to the hydraulic pump or a tank (not shown) via a switching valve (not shown). When one of the two oil chambers 11 and 12 is connected to the hydraulic pump, the other is connected to the tank. As the working oil is guided from the hydraulic pump to either one of the two oil chambers 11 and 12 and the piston rod 30 is moved in the axial direction, the cylinder 10 is extended/contracted. Although the cylinder 10 is a double-acting cylinder, it may be a single-acting cylinder. In addition, the cylinder 10 is not limited to a hydraulic cylinder, and an pneumatic cylinder, a water pressure cylinder, an electrical mechanical cylinder, or the like may also be used. In addition, the cylinder 10 is not limited to that which functions as an actuator, and the cylinder 10 may function as a shock absorber, etc.

The piston rod 30 is a columnar magnetic member having a proximal end portion 30a and a distal end portion 30b, where the proximal end portion 30a is fixed to the piston 31, and the distal end portion 30b is exposed from the cylinder tube 20. The piston rod 30 is operated by hydraulic force acting on the piston 31.

Next, the stroke detector 100 provided on the cylinder 10 will be described.

The stroke detector 100 includes a magnetic detector 50 that is disposed on the cylinder head 20a through which the piston rod 30 is inserted and a plurality of scales 60 that are formed on a side surface 30c of the piston rod 30 along the advancing/retracting direction of the piston rod 30.

The magnetic detector 50 has a first hall element 51 serving as a first magnetic flux detection part that detects a change in the magnetic flux in the direction perpendicular to the advancing/retracting direction of the piston rod 30, a first magnet 52 serving as a first magnetic-field generating part that generates a first magnetic field M1 in the direction from the piston rod 30 to the first hall element 51, a second magnet 53 serving as a second magnetic-field generating part that generates a second magnetic field M2 in the direction from the first hall element 51 to the piston rod 30, and a yoke 55 that connects the first hall element 51, the first magnet 52, and the second magnet 53.

The first hall element 51 is an element that outputs the intensity and the direction of the magnetic field by utilizing the Hall effect. The first hall element 51 is arranged so as to oppose the side surface 30c of the piston rod 30 in which the scales 60 are provided and outputs voltage in accordance with the detected intensity and the detected direction by detecting a magnetic flux density corresponding to the intensity of the magnetic field in the direction perpendicular to the axial direction of the piston rod 30. The output from the first hall element 51 is amplified by an amplifier (not shown) and is input to a stroke computing device (not shown).

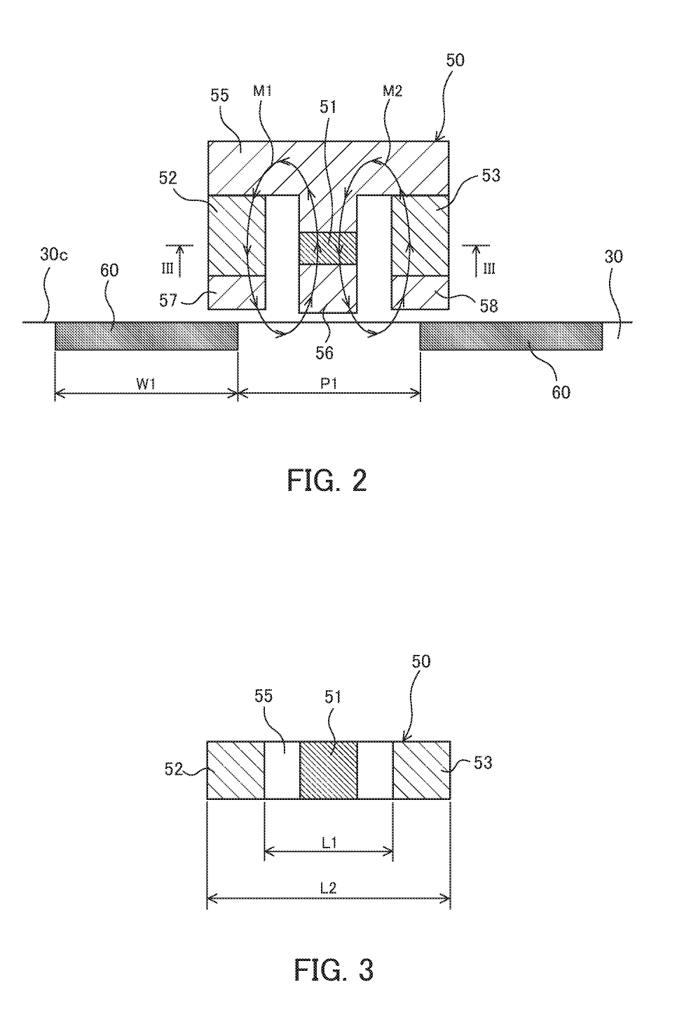

The first magnet 52 and the second magnet 53 are permanent magnets, such as neodymium magnet and ferrite magnet. The first magnet 52 is arranged such that its north pole is positioned at the piston rod 30 side, and the second magnet 53 is arranged such that its south pole is positioned at the piston rod 30 side. In addition, as shown in FIG. 2, the first magnet 52 and the second magnet 53 are respectively arranged with respect to the first hall element 51 such that, in a state in which the magnetic detector 50 is not opposing the scales 60, the first magnetic field M1 generated by the first magnet 52 and the second magnetic field M2 generated by the second magnet 53 are cancelled out in the first hall element 51.

If the intensity of the first magnetic field M1 generated by the first magnet 52 is the same as the intensity of the second magnetic field M2 generated by the second magnet 53, by arranging the first hall element 51 precisely at the central position between the first magnet 52 and the second magnet 53, the magnetic field in the first hall element 51 is cancelled, and the output voltage of the first hall element 51 becomes zero. In other words, with the first hall element 51, the magnetic flux density that corresponds to the difference between the intensity of the first magnetic field M1 and the intensity of the second magnetic field M2 at a position where the first hall element 51 is provided is detected.

In order to prevent the magnetism of each of the magnets 52 and 53 from directly acting on the first hall element 51, spaces are respectively provided between the first hall element 51 and the first magnet 52 and between the first hall element 51 and the second magnet 53. These spaces may be filled with a resin capable of shielding the magnetism.

The magnetic-field generating part is not limited to a magnet, and the magnetic-field generating part may be an electromagnet formed by winding a coil to an iron material. In this case, because the intensity of the magnetic field generated can be changed by adjusting current to be applied to the coil, it is easy to cancel the magnetic field in the first hall element 51. In addition, the magnetic flux detection part is not limited to the hall element, and the magnetic flux detection part may be a coil the axial center of which is arranged in the direction perpendicular to the advancing/retracting direction of the piston rod 30. In this case, the impedance of the magnetized coil changes in accordance with the magnetic flux density, and therefore, it is possible to track the change in the magnetic field by detecting the impedance.

The yoke 55 is made of an iron material that forms a magnetic circuit between the first hall element 51 and the first magnet 52 and between the first hall element 51 and the second magnet 53. In addition, the first hall element 51, the first magnet 52, and the second magnet 53 are integrally joined with the yoke 55.

In addition, similarly to the yoke 55, an opposing portion 56 is provided on the piston rod 30 side of the first hall element 51 to form the magnetic circuit. The opposing portion 56 is formed of an iron material, and the surface of the opposing portion 56 opposing the piston rod 30 is formed to have a concaved shape in such a manner as to match with the shape of the side surface 30c of the piston rod 30. Opposing portions 57 and 58 are respectively provided on the piston rod 30 side of the first magnet 52 and the second magnet 53. By providing the opposing portions 56 to 58 having above-described configurations, it is possible to bring the magnetic detector 50 closer to the piston rod 30 having a curved surface as much as possible.

Instead of the configuration including the opposing portions 57 and 58, it is possible to employ a configuration in which the surface of each of the magnets 52 and 53 opposing the piston rod 30 is processed to a concaved shape in such a manner as to match the shape of the side surface 30c of the piston rod 30. In addition, if the surface of the piston rod 30 opposing the magnetic detector 50 is flat, the opposing portions 56 to 58 may not be provided.

The scales 60 are non-magnetic bodies that are formed to have a groove shape on the outer circumference of the piston rod 30, which is a magnetic body. The scales 60 are formed by melting the outer circumferential surface of the piston rod 30 with a laser beam radiated by a laser device as a local heating device and by austenitizing the outer circumferential surface by doping Ni or Mn thereto.

The piston rod 30 may be formed of a non-magnetic body, and in this case, the scales 60 are formed as magnetic bodies by melting the piston rod 30 by a laser device and by doping Sn etc. Means to perform local heating is not limited to the use of a laser beam, and any means capable of performing local heating, such as use of electron beam, high frequency induction heating, arc discharge, and so forth, may also be used.

As shown in FIG. 2 in an enlarged view, the scales 60 each have a predetermined width W1 in the advancing/retracting direction of the piston rod 30 and are provided along the advancing/retracting direction of the piston rod 30 with predetermined intervals P1. The width W1 of the scales 60 is set so as to be the same as the intervals P1 at which the scales 60 are provided.

As shown in FIG. 2, with respect to the scales 60, the magnetic detector 50 is arranged such that the direction in which the first magnet 52 and the second magnet 53 are aligned is parallel to the advancing/retracting direction of the piston rod 30. The width W1 of the scales 60 is set so as to satisfy the relationship L1<W1<L2, where L1 is the length between the respective opposing-side end surfaces of the first magnet 52 and the second magnet 53 (length between inner sides), and L2 is the length between respective end surfaces of the first magnet 52 and the second magnet 53 on the other sides of the respective opposing-side end surfaces (length between outer sides).

The width W1 of the scales 60 means the length of the scales 60 in the direction in which the first magnet 52 and the second magnet 53 are aligned, in other words, the length of the scales 60 in the advancing/retracting direction of the piston rod 30, that is the direction in which the length of the scales 60 opposing the magnetic detector 50 changes in accordance with advancing/retracting movement of the piston rod 30. By setting the width W1 of the scales 60 such that the above-mentioned relationship is satisfied, as described below, the output from the magnetic detector 50 will be changed in accordance with a stroke amount.

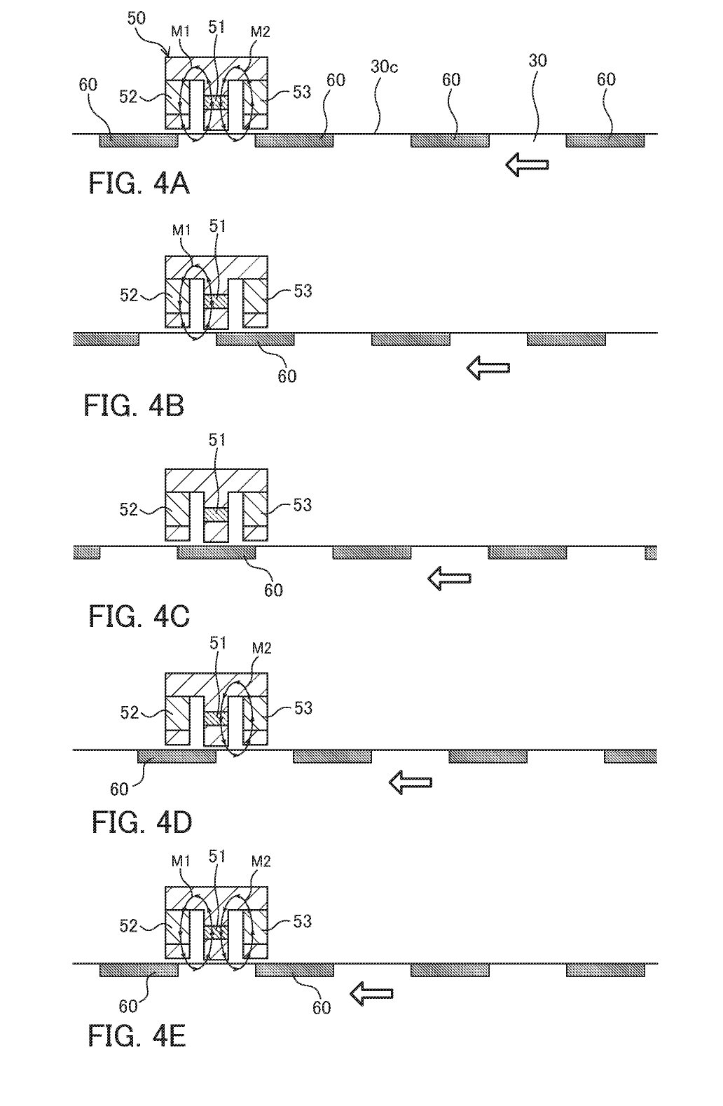

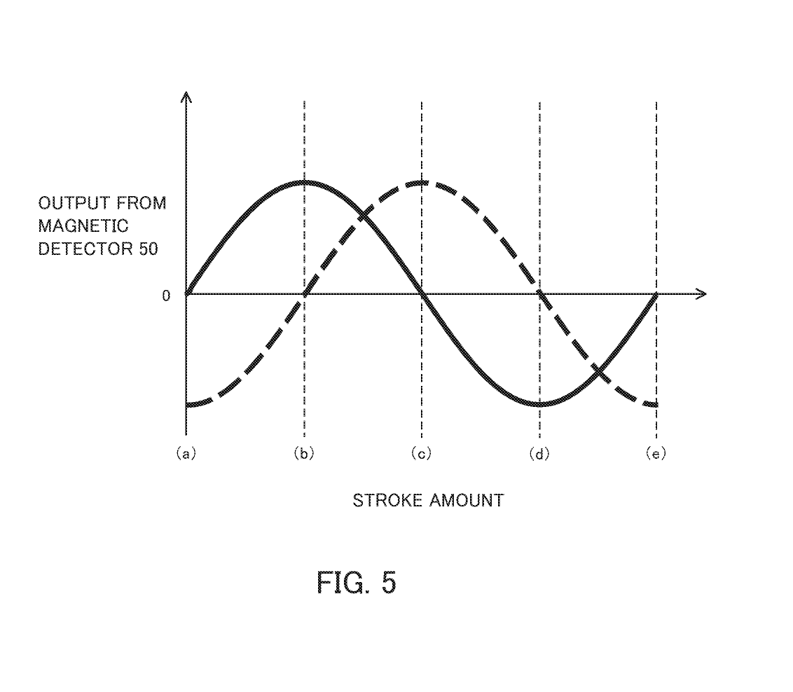

Next, detection steps of the stroke amount of the piston rod 30 by the stroke detector 100 will be described with reference to FIGS. 4A to 4E, and 5. FIGS. 4A to 4E show positional relationships between the magnetic detector 50 and the scales 60 when the cylinder 10 is extended. FIG. 5 is a graph showing a change in the output from the magnetic detector 50 when the cylinder 10 is extended as shown in FIGS. 4A to 4E.

In the state shown in FIG. 4A, the magnetic detector 50 is first brought into a state in which a portion over the first magnet 52 to the second magnet 53 opposes the side surface 30c of the piston rod 30 where the scales 60 are not provided. Because the piston rod 30 is made of a magnetic body, the first magnetic field M1 generated by the first magnet 52 and the second magnetic field M2 generated by the second magnet 53 are formed so as to respectively pass through the first hall element 51. Here, as described above, the first magnetic field M1 and the second magnetic field M2 are formed so as to be cancelled out at a position where the first hall element 51 is provided. Therefore, the magnetic flux density at the position where the first hall element 51 is provided becomes substantially zero, and the voltage output from the first hall element 51, in other words, the output value from the magnetic detector 50 becomes zero.

As the cylinder 10 is extended slightly from the state shown in FIG. 4A and the state shown in FIG. 4B is established, a state in which a portion over the second magnet 53 to the first hall element 51 opposes the scale 60 is achieved. As described above, when the portion over the second magnet 53 to the first hall element 51 opposes the scale 60 made of a non-magnetic body, the second magnetic field M2 generated by the second magnet 53 is shielded by the non-magnetic body, and the influence of the second magnetic field M2 on the first hall element 51 is reduced. On the other hand, the first magnetic field M1 is formed so as to pass through the first hall element 51 via the piston rod 30. Accordingly, a state in which the magnetic flux density at the position where the first hall element 51 is provided is increased in the direction from the piston rod 30 to the first hall element 51 is achieved. As a result, when the direction of the magnetic flux density directed from the piston rod 30 towards the first hall element 51 is defined as a positive direction, the output value from the magnetic detector 50 is maximized towards the positive side.

Until the state shown in FIG. 4A is shifted to the state shown in FIG. 4B, the intensity of the first magnetic field M1 in the first hall element 51 does not change, however, the intensity of the second magnetic field M2 is gradually reduced as the scale 60 is gradually caused to oppose the second magnet 53. In other words, until the state shown in FIG. 4A is shifted to the state shown in FIG. 4B, the magnetic flux density at the position where the first hall element 51 is provided is gradually increased in the direction from the piston rod 30 to the first hall element 51. Accordingly, until the state shown in FIG. 4A is shifted to the state shown in FIG. 4B, the output value from the magnetic detector 50 is gradually increased as shown by a solid line in FIG. 5.

Furthermore, as the cylinder 10 is extended slightly and the state shown in FIG. 4C is established, a state in which the portion over the first magnet 52 to the second magnet 53 opposes the scale 60 is achieved. As described above, when the portion over the first magnet 52 to the second magnet 53 opposes the scale 60 made of a non-magnetic body, both of the first magnetic field M1 and the second magnetic field M2 are shielded. As a result, the output value from the magnetic detector 50 becomes zero. In practice, although it is thought that the first magnetic field M1 and the second magnetic field M2 formed in the first hall element 51 are weak, because the first magnetic field M1 and the second magnetic field M2 have the similar intensity, the first magnetic field M1 and the second magnetic field M2 are cancelled out at the position where the first hall element 51 is provided.

As the state shown in FIG. 4D is established, a state in which a portion over the first magnet 52 to the first hall element 51 opposes the scale 60 is achieved. As described above, when the portion over the first magnet 52 to the first hall element 51 opposes the scale 60 made of a non-magnetic body, the first magnetic field M1 generated by the first magnet 52 is shielded by the non-magnetic body, and the influence of the first magnetic field M1 on the first hall element 51 is reduced. On the other hand, the second magnetic field M2 is formed so as to pass through the first hall element 51 via the piston rod 30. Accordingly, a state in which the magnetic flux density at the position where the first hall element 51 is provided is increased in the direction from the first hall element 51 to the piston rod 30 is achieved. As a result, when the direction of the magnetic flux density directed from the piston rod 30 towards the first hall element 51 is defined as the positive direction, the output value from the magnetic detector 50 is maximized towards the negative side.

The state shown in FIG. 4E is the same as the state shown in FIG. 4A, and the output value from the magnetic detector 50 becomes zero. As described above, the output value from the magnetic detector 50 changes sinusoidally in accordance with the stroke amount of the piston rod 30. Accordingly, on the basis of the change in the output value from the magnetic detector 50 in accordance with the stroke amount of the piston rod 30, it is possible to compute the absolute stroke amount of the piston rod 30 with respect to the cylinder tube 20.

If the width W1 of the scales 60 is equal to or longer than the length L2 between outer sides, a period during which the portion over the first magnet 52 to the second magnet 53 opposes the scales 60 is increased. In other words, a period during which the output value from the magnetic detector 50 is kept at zero is caused even when the piston rod 30 is being displaced. As a result, it becomes impossible to change the output from the magnetic detector 50 in accordance with the stroke amount.

In addition, if the width W1 of the scales 60 is equal to or shorter than the length L1 between inner sides, a period during which the portion over the first magnet 52 to the second magnet 53 opposes the scales 60 at the same time cannot be obtained. Accordingly, at the position where the first hall element 51 is provided, it becomes difficult to cause the difference between the intensity of the first magnetic field M1 and the intensity of the second magnetic field M2, and the direction of the magnetic flux density is changed frequently. As a result, the output value from the magnetic detector 50 is also changed frequently in accordance with the stroke amount, and it becomes difficult to change the output from the magnetic detector 50 in accordance with the stroke amount. For such a reason, the width W1 of the scales 60 is set so as to satisfy the relationship described above.

According to the first embodiment, the advantages described below are afforded.

With the stroke detector 100, the first magnetic field M1 generated by the first magnet 52 and the second magnetic field M2 generated by the second magnet 53 are cancelled out in the first hall element 51. Accordingly, the maximum detection range of the first hall element 51 is set in accordance with the difference between the intensity of the first magnetic field M1 and the intensity of the second magnetic field M2, which are changed in accordance with the change in the stroke, and is not set in accordance with the intensity of the magnetic fields respectively generated by each of the magnets 52 and 53. As a result, it is possible to increase a resolution of the first hall element 51 and to detect the change in the magnetic field even when the changed amount of the stroke is small and the change in the magnetic field is small.

In addition, the length W1 of the scales 60 in the direction in which the first magnet 52 and the second magnet 53 are aligned is set on the basis of the length L1 between inner sides and the length L2 between outer sides for the first magnet 52 and the second magnet 53. Accordingly, the output from the magnetic detector 50 is changed in accordance with the stroke amount. As described above, with the stroke detector 100, the magnetic detector 50 having the above described configurations and the scales 60 having the above described settings are provided, and thereby, it is possible to improve the detection precision of the stroke.

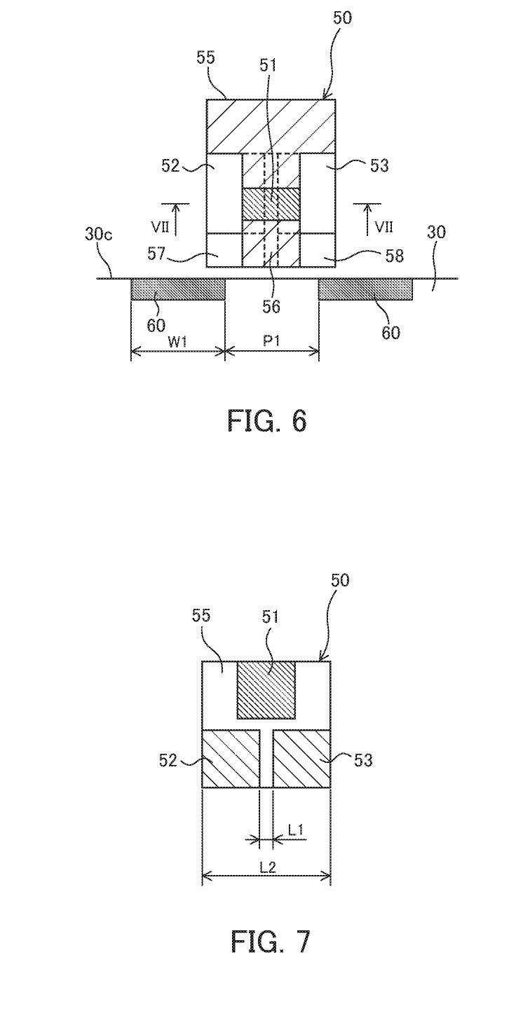

Next, a first modification of the stroke detector 100 according to the first embodiment of the present invention will be described with reference to FIGS. 6 and 7.

In the above-mentioned first embodiment, the first hall element 51 is arranged between the first magnet 52 and the second magnet 53. Instead of this configuration, the first hall element 51 may be arranged at a position separated away from the first magnet 52 and the second magnet 53 in the direction perpendicular to the direction in which the first magnet 52 and the second magnet 53 are aligned.

Even with such an arrangement, similarly to the above-mentioned embodiment, the first magnetic field M1 generated by the first magnet 52 and the second magnetic field M2 generated by the second magnet 53 are cancelled out in the first hall element 51. In addition, the width W1 of the scales 60 is set so as to satisfy the relationship L1<W1<L2, where L1 is the length between the respective opposing-side end surfaces of the first magnet 52 and the second magnet 53 (length between inner sides), and L2 is the length between respective end surfaces of the first magnet 52 and the second magnet 53 on the other sides of the respective opposing-side end surfaces (length between outer sides).

Therefore, the similar effects as those of the above-mentioned embodiment are afforded, and it is possible to easily achieve installation even when an installation space is limited, because the length L2 of the magnetic detector 50 in the advancing/retracting direction of the piston rod 30 becomes shorter as compared with the above-mentioned embodiment.

Next, a second modification of the stroke detector 100 according to the first embodiment of the present invention will be described with reference to FIGS. 5, 8, and 9.

In the above-mentioned first embodiment, only one magnetic detector 50 is provided. Instead of this configuration, a plurality of magnetic detectors 50 may be arranged. In this case, it is preferred that the plurality of magnetic detectors 50 be respectively arranged such that peak values are output for different stroke amounts. For example, when additional magnetic detector 50 is provided in addition to the magnetic detector 50, the additional magnetic detector 50 is arranged such that, with respect to the cylinder tube 20, the output from the additional magnetic detector 50 shown by the broken line in FIG. 5 differs from the output from the magnetic detector 50 shown by the solid line in that the stroke amounts at which the peak values are output are different. As described above, by providing the plurality of magnetic detectors 50 that output peak values at different stroke amounts, it is possible to easily compute the stroke direction and the absolute stroke amount of the piston rod 30.

The plurality of magnetic detectors 50, for example, may be arranged along the advancing/retracting direction of the piston rod 30 continuously or with predetermined intervals. In addition, the plurality of magnetic detectors 50 may be arranged such that parts thereof are overlapped in the circumferential direction of the piston rod 30. When the plurality of magnetic detectors 50 are used in this manner, it is possible to arrange the magnetic detectors 50 in a compact manner by using the magnetic detectors 50 having the shape shown in the above-mentioned first modification.

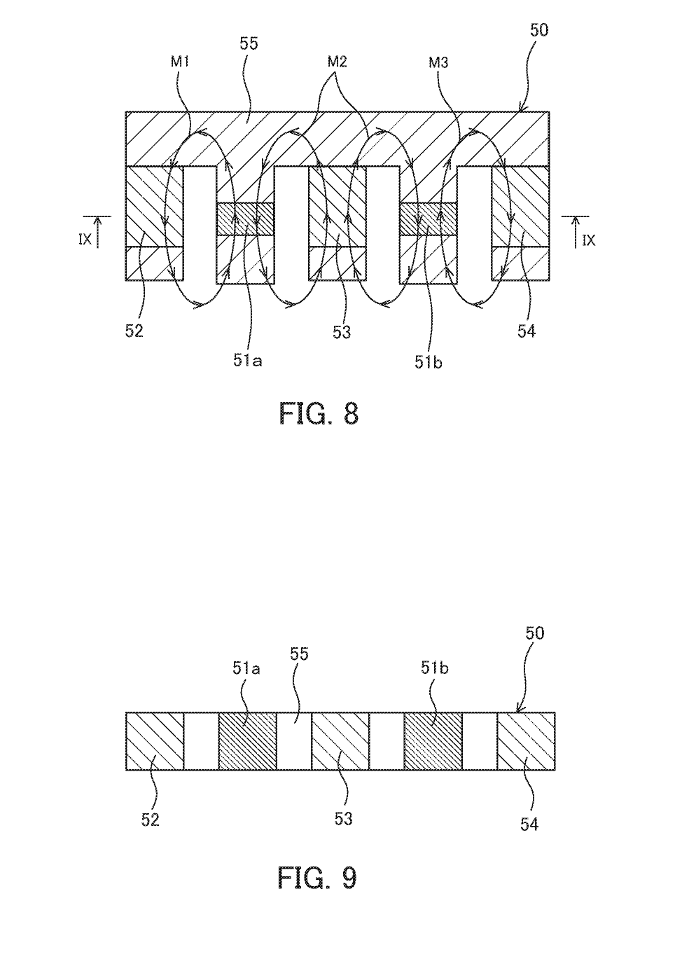

In addition, when the plurality of magnetic detectors 50 are used, the magnetic detector 50 shown in FIGS. 8 and 9 may be used. This magnetic detector 50 has two hall elements, a first hall element 51a serving as the first magnetic flux detection part, a second hall element 51b serving as a second magnetic flux detection part, and has a third magnet 54 serving as a third magnetic-field generating part that generates a third magnetic field M3 in the direction from the piston rod 30 to the second hall element 51b.

With the magnetic detector 50 having the above described configurations, the second magnet 53 that generates the magnetic field directed from the first hall element 51a towards the piston rod 30 is also used as a magnet that generates the magnetic field directed from the second hall element 51b towards the piston rod 30. As described above, there is no need to arrange two magnets for each of the hall elements 51a and 51b, and therefore, it is possible to reduce the manufacturing costs of the magnetic detector 50 and it is possible to make the magnetic detector 50 to have a compact configuration.

### Second Embodiment

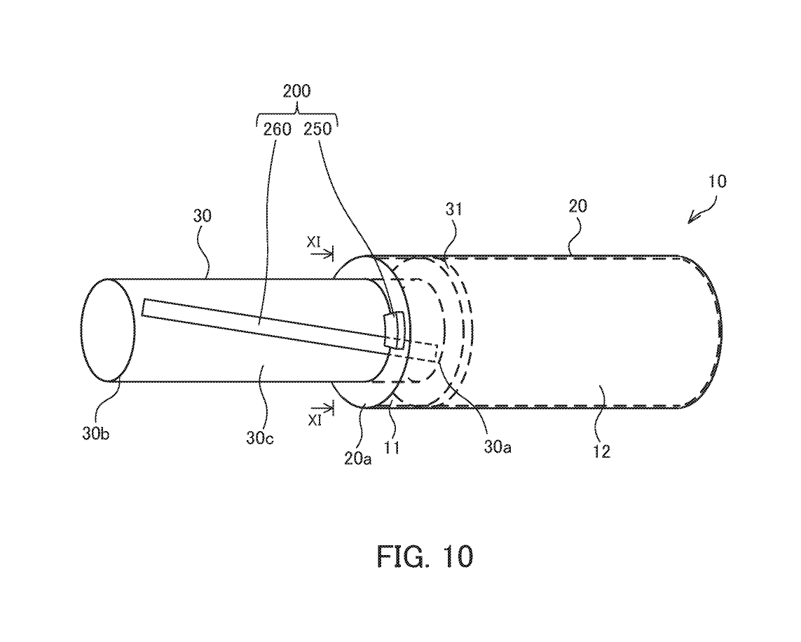

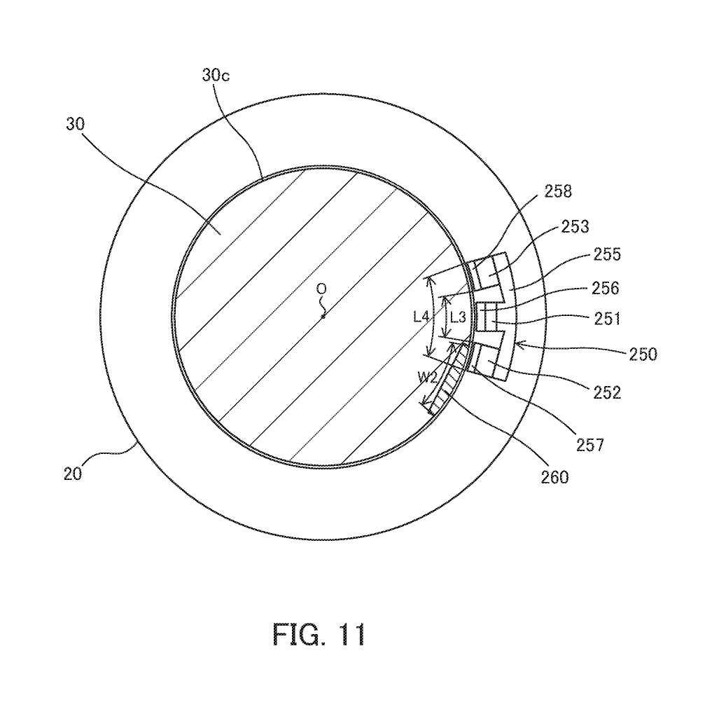

Next, a stroke detector 200 according to a second embodiment of the present invention will be described with reference to FIGS. 10 and 11. In the following, differences from the first embodiment will be mainly described, and components that are the same as those in the first embodiment are assigned the same reference numerals and descriptions thereof will be omitted.

The basic configuration of the stroke detector 200 is similar to that of the stroke detector 100 according to the first embodiment. The stroke detector 200 differs from the stroke detector 100 in that a helical scale 260 is provided along the axial direction of the piston rod 30, and a magnetic detector 250 is arranged so as to oppose the scale 260 that is displaced in the circumferential direction in accordance with the stroke amount of the piston rod 30.

The magnetic detector 250 has a first hall element 251 serving as the first magnetic flux detection part that detects a change in the magnetic flux, a first magnet 252 serving as the first magnetic-field generating part that generates the first magnetic field M1, a second magnet 253 serving as the second magnetic-field generating part that generates the second magnetic field M2, and a yoke 255 with which the first hall element 251, the first magnet 252, and the second magnet 253 are joined. The configurations of these components are similar to those of the magnetic detector 50 of the above-mentioned first embodiment, and detailed description of the respective configurations will be omitted.

In addition, similarly to the yoke 255, an opposing portion 256 is provided on the piston rod 30 side of the first hall element 251 to form the magnetic circuit. The opposing portion 256 is made of an iron material, and the surface of the opposing portion 256 opposing the piston rod 30 is formed to have a concaved shape in such a manner as to match with the shape of the side surface 30c of the piston rod 30. Opposing portions 257 and 258 are respectively provided on the piston rod 30 side of the first magnet 252 and the second magnet 253. Accordingly, the surface of the magnetic detector 250 opposing the piston rod 30 is formed to have an arc shape. By providing the opposing portions 256 to 258 having above-described configurations, it is possible to bring the magnetic detector 250 closer to the piston rod 30 having a curved surface as much as possible.

The scale 260 is a band-shaped non-magnetic body formed on the surface of the piston rod 30 and are provided so as to be inclined with respect to the advancing/retracting direction of the piston rod 30. Specifically, the scale 260 is helically formed on the surface of the cylindrical piston rod 30 along the axial direction.

As shown in FIG. 11, with respect to the scale 260, the magnetic detector 250 is arranged such that the direction in which the first magnet 252 and the second magnet 253 are aligned is perpendicular to the advancing/retracting direction of the piston rod 30. A width W2 of the scale 260 is set so as to satisfy the relationship L3<W2<L4, where L3 is the length between the respective opposing-side end surfaces of the first magnet 252 and the second magnet 253 (length between inner sides), and L4 is the length between respective end surfaces of the first magnet 252 and the second magnet 253 on the other sides of the respective opposing-side end surfaces (length between outer sides).

The width W2 of the scale 260 means the length of the scale 260 in the direction in which the first magnet 252 and the second magnet 253 are aligned, in other words, the length of the scale 260 in the circumferential direction of the piston rod 30 that is the direction in which the length of the scale 260 opposing the magnetic detector 250 changes in accordance with advancing/retracting movement of the piston rod 30. By setting the width W2 of the scale 260 such that the above-mentioned relationship is satisfied, as described below, the output from the magnetic detector 250 will be changed in accordance with a stroke amount.

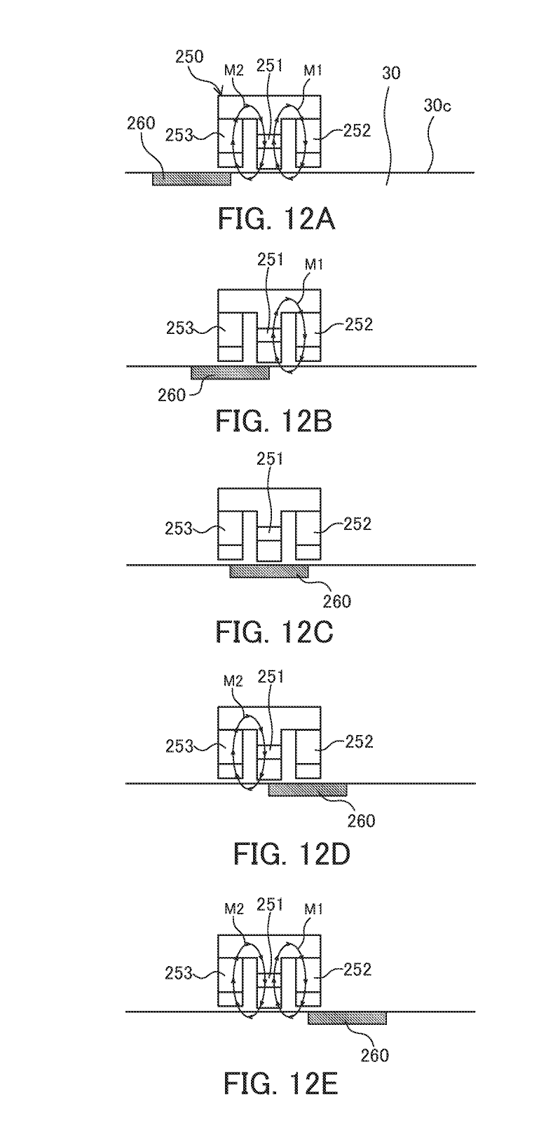

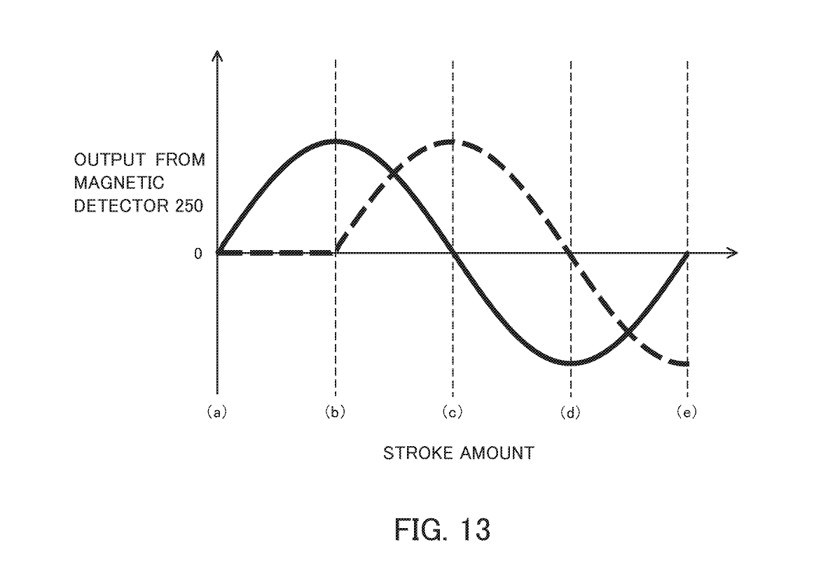

Next, detection steps of the stroke amount of the piston rod 30 by the stroke detector 200 will be described with reference to FIGS. 12A to 12E, and 13. FIGS. 12A to 12E show positional relationships between the magnetic detector 250 and the scale 260 when the cylinder 10 is extended. As shown in FIG. 11, the magnetic detector 250 and the scale 260 have a shape that matches with the surface of the piston rod 30 in the circumferential direction, however, FIGS. 12A to 12E shows a state in which the magnetic detector 250 and the scale 260 are expanded on a straight line. FIG. 13 is a graph showing a change in the output from the magnetic detector 250 when the cylinder 10 is extended as shown in FIGS. 12A to 12E.

In the state shown in FIG. 12A, the magnetic detector 250 is first brought into a state in which a portion over the first magnet 252 to the second magnet 253 opposes the side surface 30c of the piston rod 30 where the scale 260 is not provided. Because the piston rod 30 is made of a magnetic body, the first magnetic field M1 generated by the first magnet 252 and the second magnetic field M2 generated by the second magnet 253 are formed so as to respectively pass through the first hall element 251. Here, the first magnetic field M1 and the second magnetic field M2 are formed so as to be cancelled out at a position where the first hall element 251 is provided. Therefore, the magnetic flux density at the position where the first hall element 251 is provided becomes substantially zero, and the voltage output from the first hall element 251, in other words, the output value from the magnetic detector 250 becomes zero.

As the cylinder 10 is extended slightly from the state shown in FIG. 12A and the state shown in FIG. 12B is established, a state in which a portion over the second magnet 253 to the first hall element 251 opposes the scale 260 is achieved. As described above, when the portion over the second magnet 253 to the first hall element 251 opposes the scale 260 made of a non-magnetic body, the second magnetic field M2 generated by the second magnet 253 is shielded by the non-magnetic body, and the influence of the second magnetic field M2 on the first hall element 251 is reduced. On the other hand, the first magnetic field M1 is formed so as to pass through the first hall element 251 via the piston rod 30. Accordingly, a state in which the magnetic flux density at the position where the first hall element 251 is provided is increased in the direction from the piston rod 30 to the first hall element 251 is achieved. As a result, when the direction of the magnetic flux density directed from the piston rod 30 towards the first hall element 251 is defined as a positive direction, the output value from the magnetic detector 250 is maximized towards the positive side.

Until the state shown in FIG. 12A is shifted to the state shown in FIG. 12B, the intensity of the first magnetic field M1 in the first hall element 251 does not change, however, the intensity of the second magnetic field M2 is gradually reduced as the scale 260 is gradually caused to oppose the second magnet 253. In other words, until the state shown in FIG. 12A is shifted to the state shown in FIG. 12B, the magnetic flux density at the position where the first hall element 251 is provided is gradually increased in the direction from the piston rod 30 to the first hall element 251. Accordingly, until the state shown in FIG. 12A is shifted to the state shown in FIG. 12B, the output value from the magnetic detector 250 is gradually increased as shown by a solid line in FIG. 13.

Furthermore, as the cylinder 10 is extended slightly and the state shown in FIG. 12C is established, a state in which the portion over the first magnet 252 to the second magnet 253 opposes the scale 260 is achieved. As described above, when the portion over the first magnet 252 to the second magnet 253 opposes the scale 260 made of a non-magnetic body, both of the first magnetic field M1 and the second magnetic field M2 are shielded. As a result, the output value from the magnetic detector 250 becomes zero. In practice, although it is thought that the first magnetic field M1 and the second magnetic field M2 formed in the first hall element 251 are weak, because the first magnetic field M1 and the second magnetic field M2 have the similar intensity, the first magnetic field M1 and the second magnetic field M2 are finally cancelled out at the position where the first hall element 251 is provided.

As the state shown in FIG. 12D is established, a state in which a portion over the first magnet 252 to the first hall element 251 opposes the scale 260 is achieved. As described above, when the portion over the first magnet 252 to the first hall element 251 opposes the scale 260 made of a non-magnetic body, the first magnetic field M1 generated by the first magnet 252 is shielded by the non-magnetic body, and the influence of the first magnetic field M1 on the first hall element 251 is reduced. On the other hand, the second magnetic field M2 is formed so as to pass through the first hall element 251 via the piston rod 30. Accordingly, a state in which the magnetic flux density at the position where the first hall element 251 is provided is increased in the direction from the first hall element 251 to the piston rod 30 is achieved. As a result, when the direction of the magnetic flux density directed from the piston rod 30 towards the first hall element 251 is defined as the positive direction, the output value from the magnetic detector 250 is maximized towards the negative side.

The state shown in FIG. 12E is the same as the state shown in FIG. 12A, and the output value from the magnetic detector 250 becomes zero. As described above, the output value from the magnetic detector 250 changes sinusoidally in accordance with the stroke amount of the piston rod 30. Accordingly, on the basis of the change in the output value from the magnetic detector 250 in accordance with the stroke amount of the piston rod 30, it is possible to compute the absolute stroke amount of the piston rod 30 with respect to the cylinder tube 20.

According to the second embodiment, the advantages described below are afforded.

With the stroke detector 200, the first magnetic field M1 generated by the first magnet 252 and the second magnetic field M2 generated by the second magnet 253 are cancelled out in the first hall element 251. Accordingly, the maximum detection range of the first hall element 251 is set in accordance with the difference between the intensity of the first magnetic field M1 and the intensity of the second magnetic field M2, which are changed in accordance with the change in the stroke, and is not set in accordance with the intensity of the magnetic fields respectively generated by each of the magnets 252 and 253. As a result, it is possible to increase a resolution of the first hall element 251 and to detect the change in the magnetic field even when the changed amount of the stroke is small and the change in the magnetic field is small.

In addition, the length W2 of the scale 260 in the direction in which the first magnet 252 and the second magnet 253 are aligned is set on the basis of the length L3 between inner sides and the length L4 between outer sides for the first magnet 252 and the second magnet 253. Accordingly, the output from the magnetic detector 250 is changed in accordance with the stroke amount. As described above, with the stroke detector 200, the magnetic detector 250 having the above described configurations and the scale 260 having the above described settings are provided, and thereby, it is possible to improve the detection precision of the stroke.

Next, a modification of the stroke detector 200 according to the second embodiment of the present invention will be described.

In the above-mentioned second embodiment, only one magnetic detector 250 is provided. Instead of this configuration, a plurality of magnetic detectors 250 may be arranged. In this case, it is preferred that the plurality of magnetic detectors 250 be respectively arranged such that peak values are output for different stroke amounts. For example, when additional magnetic detector 250 is provided in addition to the magnetic detector 250, the additional magnetic detector 250 is arranged such that, with respect to the cylinder tube 20, the output from the additional magnetic detector 250 shown by the broken line in FIG. 13 differs from the output from the magnetic detector 250 shown by the solid line in that the stroke amounts at which the peak values are output are different. As described above, by providing the plurality of magnetic detectors 250 that output peak values at different stroke amounts, it is possible to easily compute the stroke direction and the absolute stroke amount of the piston rod 30.

In addition, the plurality of magnetic detectors 250, for example, may be arranged along the circumferential direction of the piston rod 30 continuously or with predetermined intervals. In addition, the plurality of magnetic detectors 250 may be arranged such that parts thereof are overlapped in the advancing/retracting direction of the piston rod 30. As described above, by arranging the plurality of magnetic detectors 250 in the circumferential direction, it is possible to detect the displacement of the scale 260 continuously. As a result, even when the stroke is long, it is possible to detect the stroke amount precisely.

In addition, by arranging the plurality of magnetic detectors 250 in the circumferential direction and by increasing the inclination of the scale 260 in the advancing/retracting direction of the piston rod 30, it is possible to increase the change in the output from the magnetic detector 250 in accordance with the change in a predetermined stroke. As described above, by increasing the change in the output in accordance with the change in the stroke, it is possible to improve the detection precision of the stroke amount.

In addition, when the plurality of magnetic detectors 250 are arranged in the circumferential direction, by using the magnetic detector 50 having the shape shown in FIG. 8, it is possible to achieve a compact arrangement both in the advancing/retracting direction and the circumferential direction of the piston rod 30.

Configurations, operations, and effects of the embodiments according to the present invention will be collectively described below.

The stroke detectors 100 and 200 include the scales 60 and 260 that are provided on the surface of the piston rod 30 along the advancing/retracting direction of the piston rod 30 and the magnetic detectors 50 and 250 that are provided on the cylinder tube 20 so as to oppose the scales 60 and 260. The piston rod 30 is provided so as to be capable of advancing/retracting with respect to the cylinder tube 20, and the magnetic detectors 50 and 250 output signals in accordance with the magnetic fields, which are changed by the scales 60 and 260. The magnetic detectors 50 and 250 have: the first hall elements 51 and 251 that detect the change in the magnetic flux in the direction perpendicular to the advancing/retracting direction of the piston rod 30; the first magnets 52 and 252 that generates the first magnetic field M1 in the direction from the piston rod 30 to the first hall elements 51 and 251; and the second magnets 53 and 253 that generates the second magnetic field M2 in the direction from the first hall elements 51 and 251 to the piston rod 30. The first magnets 52 and 252 and the second magnets 53 and 253 are respectively arranged with respect to the first hall elements 51 and 251 such that, in a state in which the magnetic detectors 50 and 250 are not opposing the scales 60 and 260, the first magnetic field M1 and the second magnetic field M2 are cancelled out in the first hall elements 51 and 251.

With this configuration, the first magnetic field M1 generated by the first magnets 52 and 252 and the second magnetic field M2 generated by the second magnets 53 and 253 are cancelled out in the first hall elements 51 and 251. Accordingly, the maximum detection range of the first hall elements 51 and 251 is set in accordance with the difference between the intensity of the first magnetic field M1 and the intensity of the second magnetic field M2, which are changed in accordance with the change in the stroke, and is not set in accordance with the intensity of the magnetic fields generated by the magnets. As a result, it is possible to increase the resolution of the first hall elements 51 and 251, and to precisely detect the change in the magnetic fields even when the changed amount of the stroke is small and the change in the magnetic fields is small. As a result, it is possible to improve the detection precision of the stroke.

In addition, the lengths W1 and W2 of the scales 60 and 260 in the direction in which the first magnets 52 and 252 and the second magnets 53 and 253 are aligned are longer than the lengths L1 and L3 between inner sides of the first magnets 52 and 252 and the second magnets 53 and 253 and are shorter than the lengths L2 and L4 between outer sides of the first magnets 52 and 252 and the second magnets 53 and 253.

With this configuration, the lengths W1 and W2 of the scales 60 and 260 in the direction in which the first magnets 52 and 252 and the second magnets 53 and 253 are aligned are set on the basis of the lengths L1 and L3 between inner sides and the lengths L2 and L4 between outer sides of the first magnets 52 and 252 and the second magnets 53 and 253. Accordingly, the outputs from the magnetic detectors 50 and 250 are changed in accordance with the stroke amount. As described above, with the stroke detectors 100 and 200, the magnetic detectors 50 and 250 having above-described configurations and the scales 60 and 260 having the above described settings are provided, and thereby, it is possible to further improve the detection precision of the stroke.

In addition, the direction in which the first magnet 52 and the second magnet 53 are aligned is parallel to the advancing/retracting direction of the piston rod 30, and the plurality of scales 60 are provided with predetermined intervals.

With this configuration, the magnetic detector 50 is arranged on the cylinder tube 20 such that the direction in which the first magnet 52 and the second magnet 53 are aligned is parallel to the advancing/retracting direction of the piston rod 30, and the plurality of the scales 60 are provided on the piston rod 30 with predetermined intervals. Accordingly, as the area of the scales 60 opposing the magnetic detector 50 is changed with the stroke, the influences of the first magnetic field M1 and the second magnetic field M2 on the first hall element 51 are changed. As a result, on the basis of the output from the magnetic detector 50, it is possible to detect precise stroke amount of the piston rod 30.

In addition, the first hall element 51 is arranged at the position between outer sides of the first magnet 52 and the second magnet 53, and at a position separated away from the first magnet 52 and the second magnet 53 in the direction perpendicular to the direction in which the first magnet 52 and the second magnet 53 are aligned.

With this configuration, the first hall element 51 is not arranged between the first magnet 52 and the second magnet 53. Accordingly, the length of the magnetic detector 50 in the direction in which the first magnet 52 and the second magnet 53 are aligned, in other words, in the advancing/retracting direction of the piston rod 30 is short. As a result, it is possible to easily achieve installation even when the installation space for the magnetic detector 50 is limited, and it is possible to make the stroke detector 100 compact.

In addition, the direction in which the first magnet 252 and the second magnet 253 are aligned is perpendicular to the advancing/retracting direction of the piston rod 30, and the scale 260 is formed so as to have the band shape inclined with respect to the advancing/retracting direction of the piston rod 30.

With this configuration, the cylinder tube 20 is arranged with the magnetic detector 250 such that the direction in which the first magnet 252 and the second magnet 253 are aligned is perpendicular to the advancing/retracting direction of the piston rod 30, and the piston rod 30 is provided with the scale 260 that is formed so as to have the band shape inclined with respect to the advancing/retracting direction of the piston rod 30. Accordingly, the area of the scale 260 opposing the magnetic detector 250 is changed with the stroke, and the influences of the first magnetic field M1 and the second magnetic field M2 on the first hall element 251 are changed. As a result, on the basis of the output from the magnetic detector 250, it is possible to detect precise stroke amount of the piston rod 30.

In addition, the first hall element 251 is arranged between the first magnet 252 and the second magnet 253.

With this configuration, the first hall element 251 is arranged between the first magnet 252 and the second magnet 253. Accordingly, the thickness of the magnetic detector 250 in the direction perpendicular to the direction in which the first magnet 252 and the second magnet 253 are aligned, in other words, in the advancing/retracting direction of the piston rod 30 is thin. As a result, it is possible to easily achieve installation even when the installation space for the magnetic detector 250 is limited.

In addition, a plurality of magnetic detectors 50 and 250 are provided on the cylinder tube 20, and the plurality of magnetic detectors are respectively arranged such that the peak values are output at different stroke amounts.

With this configuration, the plurality of magnetic detectors are respectively attached to the cylinder tube 20 such that the peak values are output at different stroke amounts. As described above, because output wave forms with different phases can be obtained from the plurality of magnetic detectors, it is possible to easily compute the stroke direction and the absolute stroke amount of the piston rod 30.

In addition, the magnetic detectors 50 and 250 further have: the second hall element 51b that detects the change in the magnetic flux in the direction perpendicular to the advancing/retracting direction of the piston rod 30; and the third magnet 54 that generates the third magnetic field M3 directed from the piston rod 30 towards the second hall element 51b. The third magnet 54 is arranged with respect to the second hall element 51b such that, in a state in which the magnetic detectors 50 and 250 are not opposing the scales 60 and 260, the second magnetic field M2 and the third magnetic field M3 are cancelled out in the second hall element 51b.

With this configuration, the second magnetic field M2 generated by the second magnet 53 and the third magnetic field M3 generated by the third magnet 54 are cancelled out in the second hall element 51b. In other words, the second magnet 53 is also used as the magnetic-field generating part that generates the magnetic field directed from the second hall element 51b towards the piston rod 30. As described above, there is no need to arrange two magnets for each of the hall elements, and therefore, it is possible to reduce the manufacturing costs of the magnetic detectors 50 and 250 having two hall elements, and it is possible to make the magnetic detectors 50 and 250 to have a compact configuration.

The embodiments of the present invention described above are merely illustration of some application examples of the present invention and not of the nature to limit the technical scope of the present invention to the specific constructions of the above embodiments.

The present application claims a priority based on Japanese Patent Application No. 2015-252190 filed with the Japan Patent Office on Dec. 24, 2015, all the contents of which are hereby incorporated by reference.

1. A stroke detector comprising:
a scale provided on a surface of a second member provided so as to be capable of advancing/retracting with respect to a first member, the scale being provided along a advancing/retracting direction of the second member; and
a magnetic detector provided on the first member so as to oppose the scale, the magnetic detector being configured to output a signal in accordance with magnetic field that is changed by the scale, wherein
the magnetic detector includes
a first magnetic flux detection part configured to detect a change in magnetic flux in a direction perpendicular to the advancing/retracting direction of the second member,
a first magnetic-field generating part configured to generate a first magnetic field, and
a second magnetic-field generating part configured to generate a second magnetic field,
the first magnetic-field generating part and the second magnetic-field generating part are arranged such that, in a state in which the magnetic detector is not opposing the scale, the first magnetic field and the second magnetic field are cancelled out in the first magnetic flux detection part,
the direction in which the first magnetic-field generating part and the second magnetic-field generating part are aligned is parallel to the advancing/retracting, direction of the second member,
a plurality of the scales are provided with predetermined intervals, and
the first magnetic flux detection part is arranged at a position between outer sides of the first magnetic-field generating part and the second magnetic-field generating part, and at a position separated away from the first magnetic-field generating part and the second magnetic-field generating part in a direction perpendicular to the direction in which the first magnetic-field generating part and the second magnetic-field generating part are aligned.

2. The stroke detector according to claim 1, wherein
a length of the scale in a direction in which the first magnetic-field generating part and the second magnetic-field generating part are aligned is longer than a length between inner sides of the first magnetic-field generating part and the second magnetic-field generating part and shorter than a length between outer sides of the first magnetic-field generating part and the second magnetic-field generating part.

3. (canceled)

4. (canceled)

5. (canceled)

6. (canceled)

7. The stroke detector according to claim 1, wherein
a plurality of the magnetic detectors are provided on the first member, and
the plurality of magnetic detectors are respectively arranged such that peak values are output at different stroke amount.

8. The stroke detector according to claim 1, wherein
the magnetic detector further includes
a second magnetic flux detection part configured to detect a change in magnetic flux in the direction perpendicular to the advancing/retracting direction of the second member, and
a third magnetic-field generating part configured to generate a third magnetic field directed from the second member towards the second magnetic flux detection part, and
the third magnetic-field generating part is arranged with respect to the second magnetic flux detection part such that, in a state in which the magnetic detector is not opposing the scale, the second magnetic field and the third magnetic field are cancelled out in the second magnetic flux detection part.
